(19) United States
(12) Patent Application Publication
(10) Pub. No.: US 2009/0322655 A1
(43) Pub. Date: Dec. 31, 2009

(54) SYSTEMS AND METHODS FOR MODIFYING AN INTENSITY OF A CATHODE RAY TUBE STROKE SIGNAL WITHIN A DIGITAL DISPLAY SYSTEM

(75) Inventor: Bill A. Dickey, Corrales, NM (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/146,745

(22) Filed: Jun. 26, 2008

(51) Int. Cl. G09G 1/14; G09G 1/06

(52) U.S. Cl. 345/16; 345/20

(57) ABSTRACT

Systems and methods for modifying an intensity of a CRT stroke signal provided to a digital display displaying a stroke image are provided. One apparatus includes a velocity module for determining a vector velocity of the stroke image and an encoder for modifying the intensity of the stroke signal based on the vector velocity. A system includes a deflection input from multiple axes, a multiplexer for outputting the stroke signal, and a velocity intensity module (VIM). The VIM is configured to receive the stoke signal, determine a vector velocity of the stroke image based on the deflection inputs, and modify the stroke signal intensity based on the vector velocity. One method includes receiving first and second deflection inputs for the stroke image, determining a vector velocity for the stroke image based on the first and second deflection inputs, and modifying the stroke signal intensity based on the vector velocity.

### FIELD OF THE INVENTION

The present invention generally relates to displays, and more particularly relates to systems and methods for modifying an intensity of a cathode ray tube stroke signal provided to a digital display.

### BACKGROUND OF THE INVENTION

Conversion of analog stroke deflection-based video for a cathode ray tube (CRT) display into a digitized format for display creates differences in appearance. The CRT-based display utilizes a combination of video intensity and deflection rate or electron beam velocity to provide differences in presentation intensity of displayed data. Specifically, the faster the electron beam in the CRT display is deflected or moving, the lower the luminance of the line being drawn and vice versa. Conventional digitized stroke display conversions do not take this fact into consideration when providing the stroke signal to the digital display. As a result, some data being displayed on the digital display may include a higher or lower level of luminance than intended for a CRT display.

Accordingly, it is desirable to systems and methods for modifying an intensity of a CRT stroke signal intended for an electron beam provided to a CRT display, when applied to a digital display, to control the level of luminance of the data being displayed. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Various embodiments provide an apparatus for modifying an intensity of a cathode ray tube stroke signal provided to a digital display displaying a stroke image. One apparatus comprises a velocity circuit configured to be coupled to the digital display and configured to determine a vector velocity of the stroke image. The apparatus further comprises an encoder circuit coupled to the velocity module and configured to modify the intensity of the stroke signal based on the vector velocity.

Systems for modifying an intensity of a cathode ray tube stroke signal provided to a digital display displaying a stroke image are also provided. One system comprises a first deflection input from a first plane, a second deflection input from a second plane, a multiplexer (MUX) configured to output the stroke signal, and a velocity intensity module (VIM) coupled to the first deflection input, the second deflection input, and the MUX. The VIM is configured to receive the stoke signal, determine a vector velocity of the stroke image based on the first and second deflection inputs, and modify the intensity of the stroke signal based on the vector velocity.

Also provided are methods for modifying an intensity of a cathode ray tube stroke signal provided to a digital display displaying a stroke image. One method comprises the steps of receiving a first deflection input and a second deflection input for the stroke image, determining a vector velocity of the stroke image based on the first and second deflection inputs, and modifying the intensity of the stroke signal based on the vector velocity.

### BRIEF DESCRIPTION OF THE DRAWINGS

The present invention will hereinafter be described in conjunction with the following drawing figures, wherein like numerals denote like elements, and

FIG. 1 is a block diagram of one embodiment of a system for modifying an intensity of a cathode ray tube stroke signal provided to a digital display for displaying a stroke image; and

FIG. 2 is a block diagram of one embodiment of a velocity intensity module included in the system of FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Various embodiments of the invention provide systems and methods for modifying an intensity of a cathode ray tube (CRT) stroke signal provided to a digital display displaying a stroke image. Specifically, the systems and methods modify the intensity of the CRT stroke signal based on the vector velocity of the stroke image.

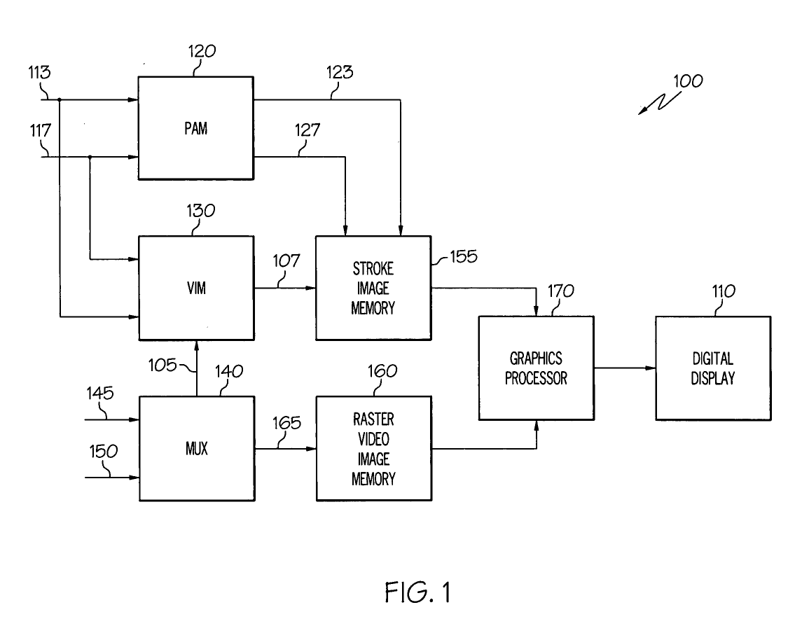

Turning now to the figures, FIG. 1 is a block diagram of one embodiment of a system 100 for modifying an intensity of a cathode ray tube stroke signal 105 provided to a digital display 110. System 100, at least in the embodiment illustrated in FIG. 1, comprises an X-axis deflection input 113, a Y-axis deflection input 117, a position addressing module (PAM) 120 coupled to X-axis deflection input 113 and Y-axis deflection input 117, and a velocity intensity module (VIM) 130 coupled to X-axis deflection input 113 and Y-axis deflection input 117. System 100 further comprises a multiplexer (MUX) 140 coupled to a raster/stroke control input 150 that alternates between selecting raster video signals 165 and stroke signals 105, and coupled to a video intensity input 145 providing the intensity for the raster video signals 165 and the stroke signals 105. Furthermore, system 100 comprises a stroke image memory 155 coupled to PAM 120 and VIM 130, a raster video image memory 160 coupled to MUX 140, a graphics processor 170 coupled to stroke image memory 155 and raster video image memory 160, and digital display 110 coupled to graphics processor 170, wherein digital display 110 may be any digital display known in the art or developed in the future.

As discussed above, the luminance of the line being drawn in a CRT display is dependent on the vector velocity at which the electron beam is being deflected (or moving) and the value of the video intensity input. That is, the faster the electron beam is deflected, the lower the luminance of the line that is being drawn on the CRT display, and vice versa. The vector velocity of the electron beam can be determined using the change in position (i.e., the X-axis deflection and the Y-axis deflection) of the electron beam over time. With this in mind, the present invention uses signals for displaying a stroke image on digital display 110 to emulate the X-axis deflection input and the Y-axis deflection input of an electron beam in a CRT display. In other words, the address and data signals used to display the stroke image on digital display 110 emulate the X-deflection input and the Y-axis input in a PAM of a CRT display.

PAM 120 may be any system, device, hardware (including software), or combinations thereof capable of determining the position of the stroke image being displayed on digital display 110. In one embodiment, PAM 120 is configured to determine the position of the stroke image based on data received from X-axis deflection input 113 and Y-axis deflection input 117. That is, PAM 120 is configured to determine the X and Y coordinates of the stroke image based on the data related to the X-plane from X-axis deflection input 113 and the data related to the Y-plane from Y-axis deflection input 117. Furthermore, PAM 120 is configured to calculate the position of the stroke image based on the X and Y coordinates, and generate a signal 123 and a signal 127 indicating the X-coordinate and the Y-coordinate, respectively. The data related to the X-plane from X-axis deflection input 113 and the data related to the Y-plane from Y-axis deflection input 117 is also provided to VIM 130.

VIM 130 may be any system, device, hardware (including software), or combinations thereof capable of modifying the intensity of a CRT stroke signal. In one embodiment, VIM 130 is configured to modify (e.g., attenuate or amplify) the intensity of stroke signal 105 supplied from MUX 140 to generate modified stroke signal 107 based on the vector velocity of the stroke image being displayed on digital display 110. Specifically, VIM 130 is configured to receive X-axis deflection input 113 and Y-axis deflection input 117, determine the vector velocity of the stroke image based on X-axis deflection input 113 and Y-axis deflection input 117, and attenuate or amplify stroke signal 105 based on the determined vector velocity. Specifically, once the vector velocity of the stroke image 105 is determined by VIM 130, a modifying velocity component is added to stroke signal 105 to generate modified stroke signal 107 so that the desired luminance of the stroke image being displayed on digital display 110 may be obtained. In other words, modified stroke signal 107 includes data emulating the vector velocity of a CRT electron beam based on X-axis deflection input 113, Y-axis deflection input 117, and the video intensity input 145, so that the stroke image being displayed on digital display 110 includes the desired level of luminance.

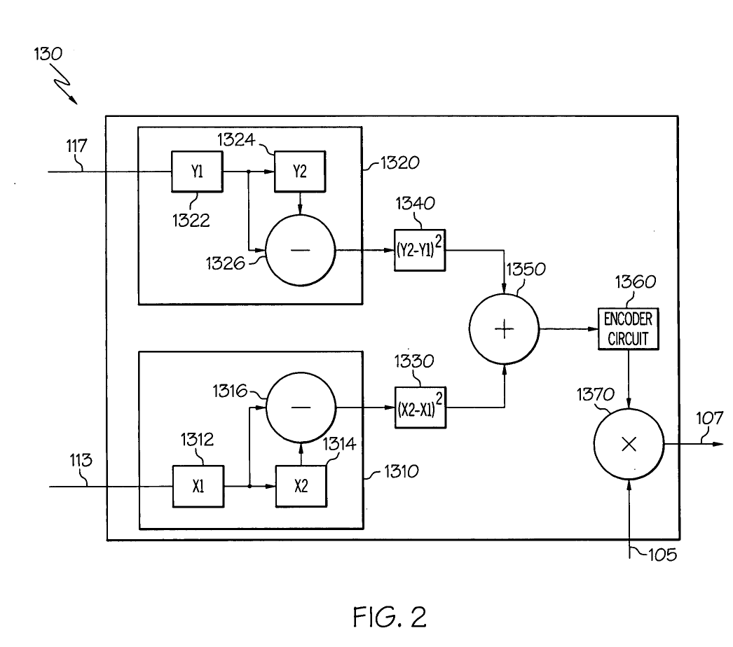

FIG. 2 is a block diagram of one exemplary embodiment of VIM 130. At least in the illustrated embodiment, VIM 130 comprises a difference circuit 1310 coupled to X-axis deflection input 113, a difference circuit 1320 coupled to Y-axis deflection input 117, a multiplier circuit 1330 coupled to difference circuit 1310, a multiplier circuit 1340 coupled to difference circuit 1320, an adder circuit coupled to multiplier circuits 1330 and 1340, an encoder circuit 1360 coupled to adder circuit 1350, and a multiplier circuit 1370 coupled to encoder circuit 1360 and configured to receive stroke signal 105 from MUX 140 (see FIG. 1).

Difference circuit 1310 comprises a memory 1312, a memory 1314, and a subtractor circuit 1316 coupled to memory 1312 and 1314. Memory 1312 is configured to receive and, at least temporarily, store a first X-coordinate for the stroke image at time T1, and memory 1314 is configured to receive and, at least temporarily, store a second X-coordinate for the stroke image at time T2, which is subsequent to time T1. Subtractor circuit 1316 is configured to receive the first and second X-coordinates, and subtract the first X-coordinate from the second X-coordinate to determine an X-value representing the change in position of the stroke image in an X-axis.

Difference circuit 1320 comprises a memory 1322, a memory 1324, and a subtractor circuit 1326 coupled to memory 1322 and 1324. Memory 1322 is configured to receive and, at least temporarily, store a first Y-coordinate for the stroke image at time T1, and memory 1324 is configured to receive and, at least temporarily, store a second Y-coordinate for the stroke image at time T2. Subtractor circuit 1326 is configured to receive the first and second Y-coordinates, and subtract the first Y-coordinate from the second Y-coordinate to determine a Y-value representing the change in position of the stroke image in a Y-axis. The X-value and the Y-value are then transmitted to multiplier circuits 1330 and 1340, respectively.

Multiplier circuit 1330 is configured to square the X-value (i.e., (X-value)²) determined by difference circuit 1310. Similarly, multiplier circuit 1340 is configured to square the Y-value (i.e., (Y-value)²) determined by difference circuit 1320. The squared X-value and the squared Y-value are then transmitted to adder circuit 1350.

Adder circuit 1350 is configured to add the squared X-value and the squared Y-value to generate an XY-value representing the vector velocity of the stroke image. The XY-value is then transmitted to encoder circuit 1360.

Encoder circuit 1360 is configured to compare the XY-value to a predetermined level of luminescence for the stroke image to be displayed and generate a coefficient that attenuates or amplifies stroke signal 105 so that modified stroke signal 107 includes a coefficient that will produce the predetermined level of luminescence for the stroke image to be displayed on digital display 110. In one embodiment, the XY-value itself is the coefficient. In another embodiment, encoder circuit 1360 includes a look-up table and is configured to generate the coefficient by matching the XY-value to a coefficient in the look-up table that corresponds to the XY-value. In this embodiment, each coefficient includes values less than, equal to, or greater than one (1). That is, the coefficient is greater than 1 (which emulates decreasing the velocity of an electron beam) if the stroke image is moving too slowly, the coefficient is equal to 1 if the stroke image is moving at the proper velocity, and the coefficient is less than 1 (which emulates increasing the velocity of an electron beam) if the stroke image is moving too fast. The coefficient is then transmitted to multiplier 1370.

Multiplier 1370 is configured to receive stroke signal 105 and multiply stroke signal 105 by the coefficient received from encoder circuit 1360 to generate modified stroke signal 107. That is, modified stroke signal 107 increases or decreases the level of luminance of the stroke image to be displayed on digital display 110. Alternatively, modified stroke signal 107 would have the effect of increasing or decreasing the vector velocity of an electron beam in a CRT display. Modified stroke signal 107 is then transmitted to stroke image memory 155 (see FIG. 1).

With reference again to FIG. 1, stroke image memory 155 is configured to receive and store modified stroke signal 107 in locations determined by signals 123 and 127, which is then available for use by graphics processor 170 (discussed below). Similarly, raster video image memory 160 is configured to receive a raster video signal 165 from MUX 140 based on its corresponding raster/stroke control signal 150.

MUX 140 is coupled to a raster/stroke control input 150 configured to alternate between providing stroke signal 105 and raster video signal 165 to MUX 140. MUX 140 is further coupled to a video intensity signal 145 that provides the intensity for stroke signal 105 or the intensity for raster video signal 165. Furthermore, MUX 140 is configured to discriminate between stroke signals 105 and raster video signals 165, and transmit each stroke signal 105 along with its corresponding video intensity signal 145 to VIM 130 and transmit each raster video signal 165 along with its corresponding video intensity signal 145 to raster video image memory 160.

Raster video image memory 160 is configured to receive and store raster video signal 165 and its corresponding video intensity signal 145. As such, raster video signal 165 and its corresponding video intensity signal 145 are made available to graphics processor 170 via raster video image memory 160.

Graphics processor 170 may be any graphics processor known in the art or developed in the future. Graphics processor 170 is configured to receive the content of modified stroke signal 107 from stroke image memory 155, and raster video signal 165 from raster video image memory 160, and combine the corresponding respective video intensity signals 145 to digital display 110 in any manner known in the art that is capable of rendering stroke and raster images on digital display 110.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. An apparatus for modifying an intensity of a cathode ray tube stroke signal provided to a digital display displaying a stroke image, comprising:
a velocity module configured to be coupled to the digital display and configured to determine a vector velocity of the stroke image; and
an encoder circuit coupled to the velocity module and configured to modify the intensity of the stroke signal based on the vector velocity.

2. The apparatus of claim 1, wherein the velocity module comprises:
a first difference circuit configured to determine a first value representing a first change in position for the stroke image in a first plane;
a first multiplier circuit coupled to the first difference circuit and configured to square the first value;
a second difference circuit configured to determine a second value representing a second change in position for the stroke image in a second plane;
a second multiplier circuit coupled to the second difference circuit and configured to square the second value; and
an adder circuit coupled to the first and second multiplier circuits and configured to sum the squared first value and the squared second value.

3. The apparatus of claim 2, wherein the encoder circuit is configured to generate one of a plurality of coefficients for attenuating or amplifying the intensity.

4. The apparatus of claim 3, wherein the encoder circuit comprises a look-up table including the plurality of coefficients, each coefficient associated with a particular sum of the squared first value and the squared second value.

5. The apparatus of claim 3, wherein the encoder circuit is configured to generate the one of a plurality of coefficients based on the sum of the squared first value and the squared second value.

6. The apparatus of claim 3, further comprising a multiplier circuit coupled to the encoder circuit and configured to be coupled to the digital display, the multiplier circuit configured to:
receive the stroke signal;
multiply the stroke signal by the generated one of the plurality of coefficients; and
transmit the multiplied stroke signal to the digital display.

7. A system for modifying an intensity of a cathode ray tube stroke signal provided to a digital display displaying a stroke image, comprising:
a first deflection input from a first plane;
a second deflection input from a second plane;
a multiplexer (MUX) configured to output the stroke signal; and
a velocity intensity module (VIM) coupled to the first deflection input, the second deflection input, and the MUX, the VIM configured to:
receive the stoke signal,
determine a vector velocity of the stroke image based on the first and second deflection inputs, and
modify the intensity of the stroke signal based on the vector velocity.

8. The system of claim 7, further comprising a position addressing module (PAM) coupled to the first input, the second input, and the digital display, the PAM configured to determine a position of the stroke image based on the first and second inputs.

9. The system of claim 8, further comprising a stroke image memory coupled to the PAM and the VIM, the stroke image memory configured to store the position and the stroke signal including the modified intensity.

10. The system of claim 9, further comprising a graphics processor coupled to the stroke image memory and the digital display, the graphics processor configured to merge the position and the stroke signal including the modified intensity, and transmit the merged position and the stroke signal including the modified intensity to the digital display.

11. The system of claim 10, wherein the MUX is further configured to output a raster video signal, the system further comprising a raster video image memory coupled to the MUX and the graphics display, the raster video image memory configured to store the raster video signal.

12. The system of claim 11, wherein the graphics processor is further configured to retrieve the raster video signal from the raster video image memory and transmit the raster video signal to the digital display.

13. The system of claim 12, wherein the graphics processor is further configured to alternate between transmitting the raster video signal and the merged position and stroke signal including the modified intensity.

14. A method for modifying an intensity of a cathode ray tube stroke signal provided to a digital display displaying a stroke image, comprising the steps of:
receiving a first deflection input for the stroke image;
receiving a second deflection input for the stroke image;
determining a vector velocity of the stroke image based on the first and second deflection inputs; and
modifying the intensity of the stroke signal based on the vector velocity.

15. The method of claim 14, wherein determining the vector velocity comprises the steps of:
determining a first value representing a first change in position for the stroke image in a first plane based on the first deflection input;
squaring the first value;
determining a second value representing a second change in position for the stroke image in a second plane based on the second deflection input;
squaring the second value; and
summing the squared first value and the squared second value.

16. The method of claim 15, wherein the modifying step comprises the step of generating one of a plurality of coefficients for attenuating or amplifying the intensity.

17. The method of claim 16, wherein the generating step comprises the step of using a look-up table including the plurality of coefficients to determine the one of the plurality of coefficients.

18. The method of claim 17, further comprising the steps of:
multiplying the stroke signal by the generated one of the plurality of coefficients to thereby modify the intensity of the stroke signal; and
transmitting the modified stroke signal to the digital display.

19. The method of claim 16, wherein the generating step comprises the step of generating the one of a plurality of coefficients based on the sum of the squared first value and the squared second value.

20. The method of claim 19, further comprising the steps of:
multiplying the stroke signal by the generated one of the plurality of coefficients to thereby modify the intensity of the stroke signal; and
transmitting the modified stroke signal to the digital display.
